(19) United States
(12) Patent Application Publication
(10) Pub. No.: US 2003/0126740 A1
(43) Pub. Date: Jul. 10, 2003

(54) Automotive framing system

(76) Inventor: Ronald G. Cuddy, Oakland, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/041,383

(22) Filed: Jan. 8, 2002

(51) Int. Cl. B23P 21/00

(52) U.S. Cl. 29/771

(57) ABSTRACT

An automotive framing system is disclosed for positioning an underbody component with at least two body side components wherein the body side components are positioned on top of the underbody component to form a body preassembly. The system includes a conveyor for sequentially moving body preassemblies to a predetermined assembly station. At least two frames are selectively positioned at the assembly station and each frame includes structural beams extending over and around the sides of a body preassembly position at the assembly station. At least one lifting rail is vertically slidably mounted to each frame and movable between an upper and a lower position. In its upper position, one or more locators on the lifting rail register with locator receptors on the underbody component so that, as the lifting rail moves from its lower and to its upper position, the lifting rail elevates the underbody component from the conveyor to a predetermined position. A lifter at the assembly station selectively moves the lifting rails between their upper and lower positions. With the lifting rails in their upper position, clamping assemblies mounted to the frame selectively engage and hold the body components at a predetermined position relative to each other whereupon the body components are secured together in any conventional fashion, such as by a tack weld or clinching system.

### BACKGROUND OF THE INVENTION

I. Field of the Invention

The present invention relates generally to automotive framing systems.

II. Description of the Prior Art

In the manufacture of automotive vehicles, a conveyor system typically transports a body preassembly sequentially along a conveyor line. Such body preassemblies comprise an underbody component, e.g. the underbody frame, and two or more body side components which are supported by the underbody component. The body side and underbody components, however, are not fixedly secured to each other in the preassembly. Instead, the underbody and body side components are merely loosely fastened together.

In order to fixedly secure the body side and underbody components together, it is imperative that the body side and underbody components be precisely positioned relative to each other prior to welding or otherwise securing the body components together. In order to accomplish such precision positioning of the body side and underbody components, there have been three previously known and widely accepted framing systems. One of these framing systems is disclosed in U.S. Pat. No. 4,670,961 to Fontaine et al. which issued on Jun. 9, 1987 and a second system is disclosed in U.S. Pat. No. 4,256,947 to De Candia which issued on Mar. 17, 1981. In these two prior art framing systems, a gantry is positioned above an assembly station at a midpoint of the conveyor line. The gantry includes clamping arms which are movable between raised and lowered positions. In their raised position, the clamping arms are positioned away from the preassembly to allow the next preassembly to be moved by the conveyor system into the assembly station. Conversely, in their engaged position, the arms swing downwardly while clamps on the arms engage predetermined location points on the various body components and clamp the body components together at preset positions relative to each other. With the body components clamped together, robotic welders or the like are used to fixedly secure the body components together.

In automotive manufacturing operations, however, it is commonplace to utilize the same conveyor to transport vehicle body preassemblies of different body styles. The location points on the body components of these different body styles differ from one style and to the next.

In order to accommodate different types of vehicles on the conveyor line, these previously known framing systems have utilized a turntable positioned above the workstation and rotatable about a vertical axis. The turntable then indexes to provide up to four sets of arms and clamps to selectively engage the location points on up to four different styles of automotive body components.

These previously known framing systems, however, suffered from a number of disadvantages. One such disadvantage was that, since the framing system is mounted wholly above the assembly line and optionally includes an indexable turntable for bringing the different clamping arms into position above the workstation, the entire framing system necessarily requires a great amount of headroom at the assembly station. Such headroom, however, may not be readily available. Furthermore, since the entire framing system is elevated above the framing station, maintenance and maintenance access is rendered more difficult.

A still further disadvantage of these previously known framing systems is that the clamping arms are repeatedly moved between their raised and their lowered position. Such movement of the arms necessarily resulted in wear after prolonged operation. Such wear, together with the tolerances required to permit the movement of the arms between the raised and lowered position as well as rotation of the turntable, translates into increased tolerances between the clamps on the framing system and the location points on the automotive body components. As such, these previously known framing systems have not been able to maintain the precision location of the body components during the assembly process with repeatability after extended operation.

In order to overcome these disadvantages of the previously known framing systems, a further framing system is disclosed in U.S. Pat. No. 5,943,768 to Ray which issued on Aug. 31, 1999. In this automotive framing system, a plurality of frames were associated with the framing system and each frame was selectively movable into the assembly station. Each frame, furthermore, included a plurality of structural members which extended both over and around the preassembly when both the preassembly and the frame were at the assembly station. Unlike the previously known framing systems, however, in the Ray automotive framing system the structural beams forming the frame were fixedly secured together and thus non-movable relative to each other. Thus, clamping assemblies mounted to the frame could selectively engage the body components and maintain the body components at predetermined positions relative to each other with high repeatability despite prolonged operation of the framing system.

One disadvantage of this previously known framing system, however, is that the lifting assembly for engaging and elevating the underbody component to a predetermined position above the conveyor was fixed at the assembly station and contained fixed locators. As such, even though the framing system could be utilized with different styles for the body side components, only a single type of underbody component, i.e. the automotive frame, could be utilized with the framing system.

### SUMMARY OF THE PRESENT INVENTION

The present invention provides an improved framing system which overcomes all of the above-mentioned disadvantages of the previously known devices.

In brief, the present invention provides an automotive framing system for positioning an underbody component and at least two body side components together in which the body side components are positioned on top of the underbody components to form a preassembly. The framing system comprises a conveyor which sequentially moves the preassemblies to a predetermined assembly station.

The framing system includes at least two frames that may be selectively positioned at the assembly station. Each frame includes structural beams which extend over and around the sides of a body preassembly positioned at the assembly station and these structural beams are fixed and thus non-movable relative to each other.

A plurality of clamp assemblies are mounted to each of the frames and these clamp assemblies are movable between an engaged position and a released position. In their engaged position, the clamping assemblies engage and hold both the body side and underbody components at a predetermined position relative to each other whereupon the body components are secured together in any conventional fashion, such as by welding. Conversely, in their released position, the clamp assemblies disengage from the body components to permit the movement of the body components, both as preassemblies or after they are fixed together, into and out from the assembly station.

At least one lifting rail is vertically slidably mounted to each frame and movable between an upper and a lower position. At least one locator is fixed to each lifting rail and this locator is adapted to register with a locator receptor on the underbody component. Consequently, as the lifting rail moves from its lower position and to its upper position, the lifting rail elevates the underbody component from the conveyor to a predetermined position.

In order to move the lifting rails between their lower and upper positions, and thus elevate the body preassembly from the conveyor and to its upper or assembly position, a lifter is provided at the assembly station. This lifter includes an abutment surface which registers with a like abutment surface on the lifting rail so that, with the frame positioned at the assembly station, actuation of the lifter from its lower and to its upper position simultaneously elevates the lifting rails from their lower and to their upper position, and vice versa.

A primary advantage of the present invention is that the lifting rails with their locations on the frames may vary from one frame and to another in order to accommodate different types of underbody components, i.e. different automotive frames. As such, each frame may be utilized at the assembly station to accommodate not only different body styles, i.e. different body side components, but also different automotive body frames.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is an end view illustrating a preferred embodiment of the present invention;

FIG. 2 is a side view illustrating the preferred embodiment of the present invention in one position;

FIG. 3 is a view similar to FIG. 2, but illustrating the system of the present invention in a second position;

FIG. 4 is a view similar to FIGS. 2 and 3, but illustrating the system in a further assembly position; and

FIG. 5 is a plan view of the framing system of the present invention.

### DETAILED DESCRIPTION OF A PREFERRED EMBODIMENT OF THE PRESENT INVENTION

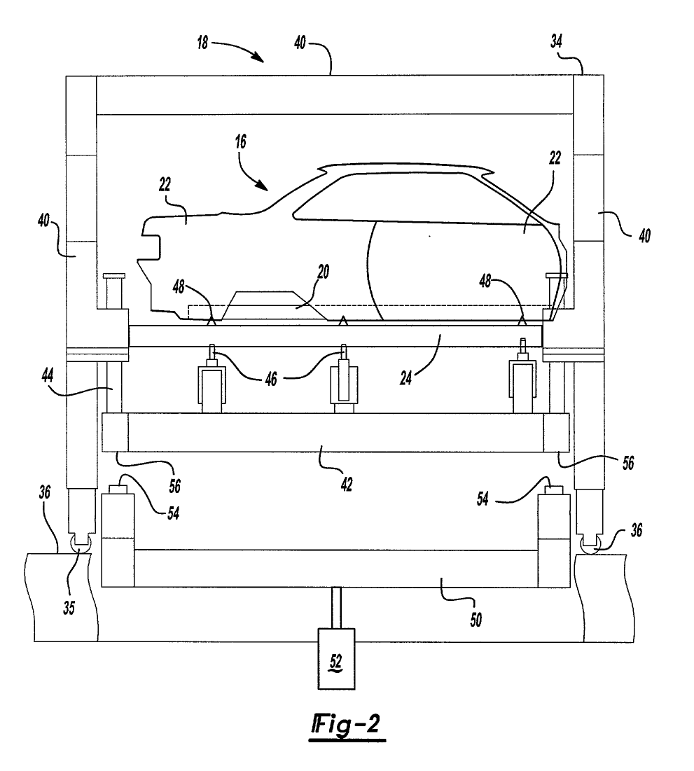

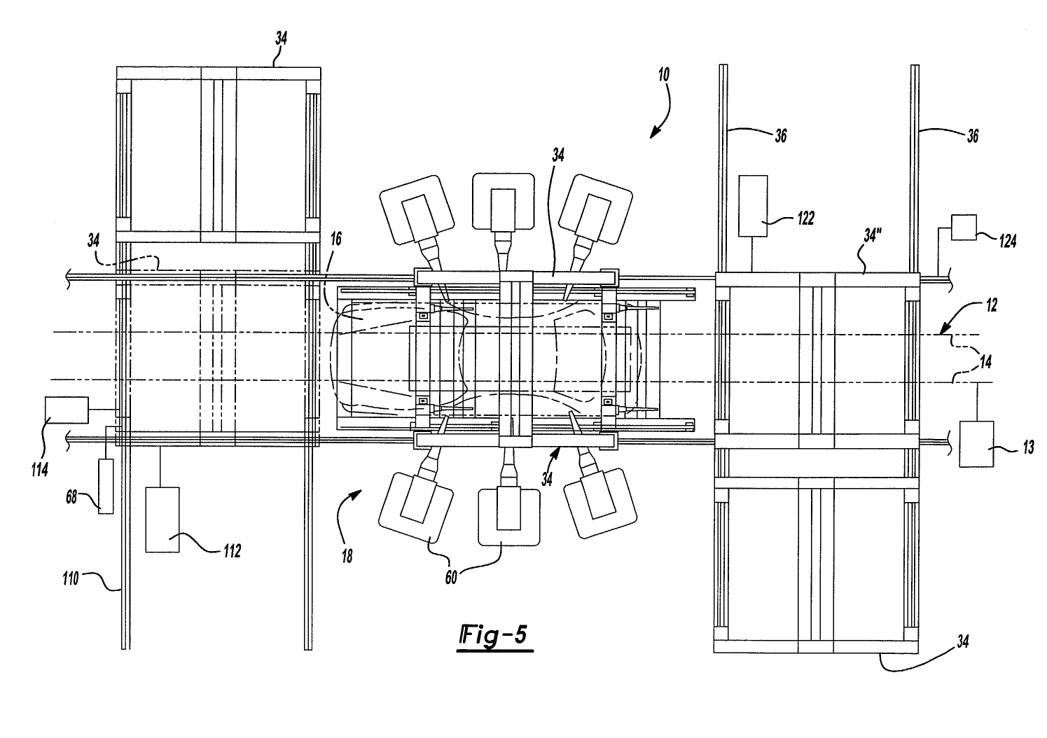

With reference first to FIG. 5, a preferred embodiment of the framing system 10 of the present invention is there shown for use with a manufacturing line for automotive vehicles. An elongated conveyor 12, preferably comprising a pair of spaced apart rails 14, sequentially conveys automotive body preassemblies 16 (only one shown) to an assembly station 18 at a midpoint on the conveyor 12. Any conventional drive means 13, illustrated only diagrammatically, is used to power the conveyor 12. Each body preassembly 16, furthermore, includes an underbody component 20 (FIG. 2), e.g. the automotive body frame, and two or more body side components 22 (FIG. 2) which are only loosely secured to each other by toy tabbing or the like.

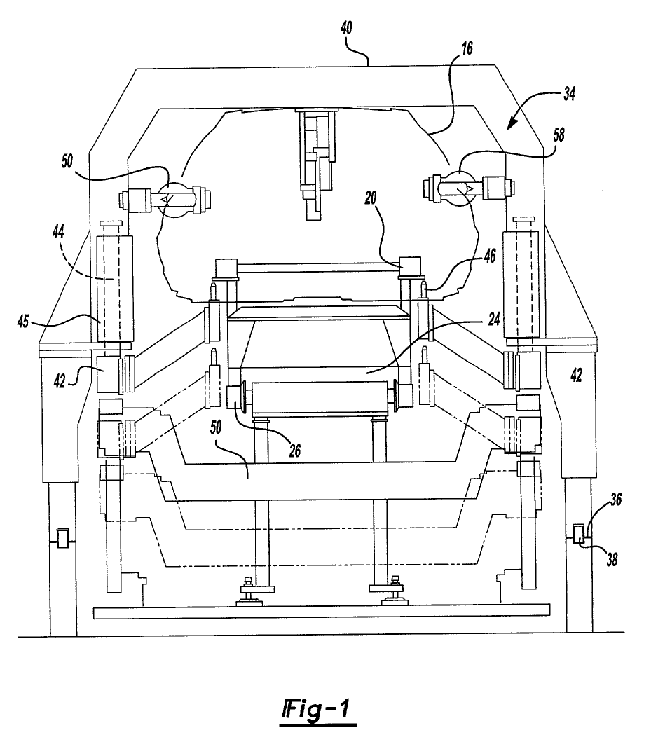

As best shown in FIG. 1, a reusable skid 24 is moveably mounted to the conveyor rails 14 by rollers 26. One skid 24 is associated with each body preassembly 16 and the skid supports the underbody component 20 while the body side components 22 in turn sit on top of the underbody component 20.

With reference particularly to FIG. 1, the framing system 10 of the present invention further comprises a plurality of frames 34 which are movably mounted on tracks 36 adjacent the assembly station 18. Any conventional means, such as rollers 38, may be used to movably mount the frames 34 to the tracks 36. Furthermore, any conventional means 112 (illustrated only diagrammatically in FIG. 5) are used to selectively position one of the frames 34 at any given time at the assembly station 18.

With reference now to FIGS. 1 and 2, each frame 34 comprises a plurality of structural beams 40 which extend both over and around the sides of the body preassembly 16 when both the body preassembly 16 and frame 34 are positioned at the assembly station 18. These structural beams 40, furthermore, are fixedly, i.e. non-movably, secured together in any conventional means, such as by bolting, welding or the like. However, since the structural beams 40 are fixedly and permanently secured together, the structural beams necessarily maintain their position relationship with respect to each other despite prolonged use of the frame 34.

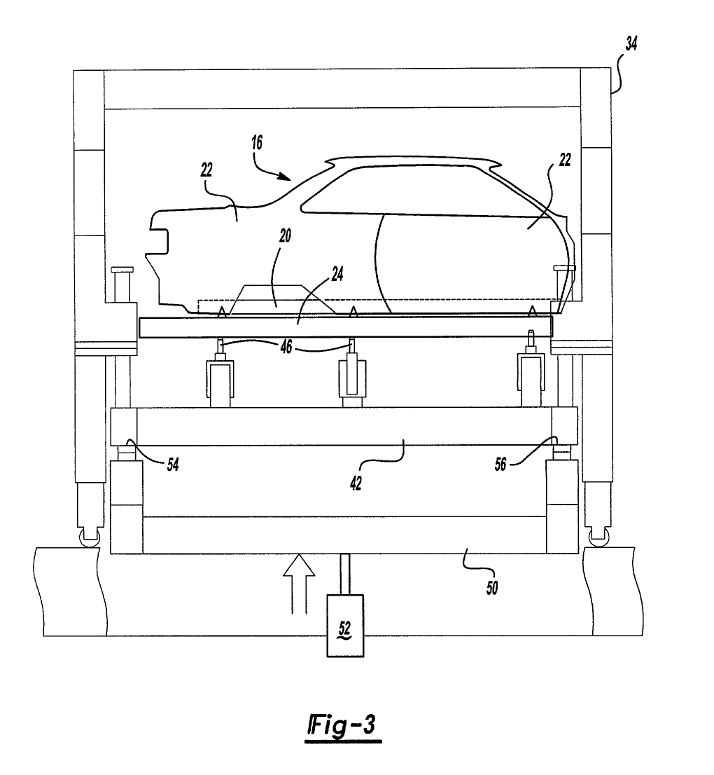

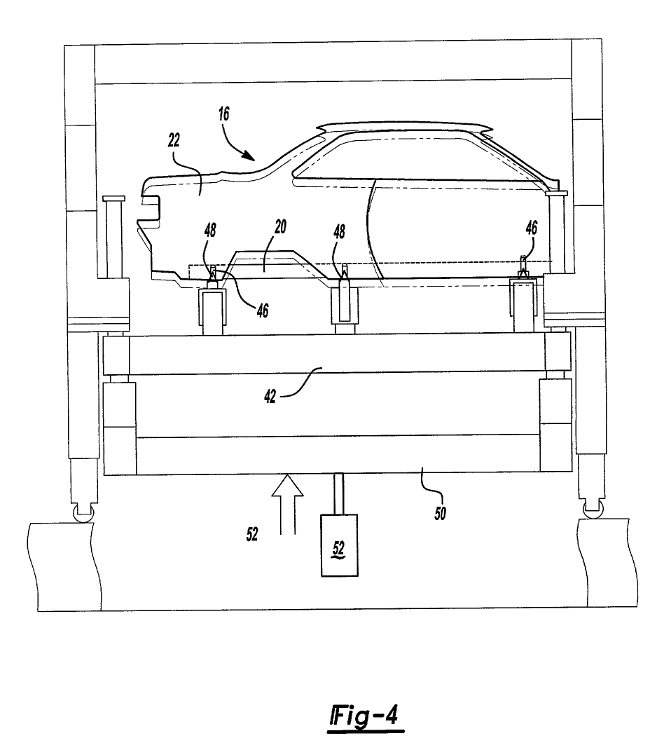

With reference still to FIGS. 1 and 2, at least one and preferably two lifting rails 42 each include slide tubes 44 which are vertically slidably mounted in slide bearings 45 mounted on the frame 34 so that the lifting rails 42 are movable between a lower position, illustrated in FIGS. 2 and 3, and an upper position, illustrated in FIG. 4. Preferably, as best shown in FIG. 1, one lifting rail 42 is positioned along one side of the frame 34 while the other lifting rail 42 is positioned along the opposite side of the frame 34.

At least one, and preferably several, locators 46 are fixedly mounted to each lifting rail 42. These locators 46 are positioned relative to both the lifting rail 42 as well as the frame 34 so that the locators 46 register with locator receptors 48 (FIG. 2) on the underbody component 20 of the preassembly 16. The position of the locators 46 may, of course, vary from one frame 34 to a different frame 34 in order to accommodate different underbody components 20.

With reference now to FIGS. 2-4, a lifter 50 is positioned at the assembly station 18 and movable from a lower position, shown in FIG. 2, to an upper position, shown in FIG. 4. Any conventional means, such as pneumatic, electric, or hydraulic actuator 52, may be utilized to move the lifter 50 between its lower and upper positions.

The lifter 50 includes at least one, and preferably several, abutment surfaces 54 which register with registering abutment surfaces 56 on the bottom of the lifting rail 42. The abutment surfaces 56 on the lifting rails 42, furthermore, are substantially identical from one frame 34 and to the other. As such, the abutment surfaces 56 on the lifting rail 50 register with the abutment surfaces 56 on the frame 34 regardless of the type or position of locators 46 secured to the lifting rail 42.

The operation of the present invention is as follows: with both the lifter 50 and the lifting rail 42 in their lower position as shown in FIG. 2, the body preassembly 16 supported by the skid 24 is first conveyed by the conveyor system 12 into the assembly station 18. At this time, the skid 24 supports both the underbody component 20 as well as the body side components 22 which are only loosely fastened together.

The actuator 52 is then actuated to the position shown in FIG. 3 thus moving the lifter from its lowermost position (FIG. 2) to an intermediate position (FIG. 3) in which the abutment surface 54 of the lifter 50 abuts against the abutment surfaces 56 on the lifting rails 42. At this intermediate position (FIG. 3) the body components 20 and 22 of the body preassembly 16 are still supported by the skid 24.

With reference now to FIG. 4, further activation of the actuator 52 moves both the lifter 50 and lifting rail 42 to their upper position. In doing so, the locators 46 on the lifting rail 42 register with their associated locator receptor 48 on the underbody component 20 and elevate both the underbody component 20 and body side components 22 to their upper assembly position.

As best shown in FIG. 1, with the lifting rail 42 in its upper position and the body preassembly 16 elevated above the skid 24 and conveyor 12, a plurality of clamping assemblies 58 mounted to the frame 34 move to an engaged position and clamp the body components 20 and 22 in a predetermined position relative to each other. These body components are then secured together by any conventional means, such as by robotic welders 60 (FIG. 5), thus securing the body components 20 and 22 together.

Following assembly of the body components 20 and 22 together, the clamp assemblies 58 are moved to their released position thus disengaging from the now assembled body components 20 and 22. The actuator 52 is then deactuated thus moving the lifter 50 and lifting rail 42 to their lower positions (FIG. 2) and illustrated in phantom line in FIG. 1 thus repositioning the now assembled body components 20 and 22 on their skid 24. Furthermore, in its lower position, the body locators 46 are positioned beneath the skid 24 so that the skid 24 may be freely moved from the assembly station 18 and a new skid with a new body preassembly moved into the assembly station 18 without interference from the body locators 46.

From the foregoing, it can be seen that a primary advantage of the framing system of the present invention is that the same assembly station may be utilized to accommodate different types of automotive frames by merely appropriately designing the position of the locators 46 on the lifting rail 42.

Having described my invention, however, many modifications thereto will become apparent to those skilled in the art to which it pertains without deviation from the spirit of the invention as defined by the scope of the appended claims.

I claim:

1. An automotive framing system for positioning an underbody component and at least two body side components together, said body side components being positioned on top of said underbody component to form a body preassembly, said framing system comprising:
a conveyor for sequentially moving body preassemblies to a predetermined assembly station,
at least two frames,
means for selectively positioning one of said frames at said assembly station,
each of said frames having structural beams extending over and around the sides of a body preassembly positioned at said assembly station, said structural beams being fixed together,
a plurality of clamp assemblies mounted to each of said frames, said clamp assemblies being movable between an engaged position in which said clamp assemblies engage and hold said body side components at a predetermined position relative to said underbody component, and a released position in which body side and underbody components are movable relative to said clamp assemblies,
at least one lifting rail vertically slidably movably mounted to each frame between an upper position and a lower position,
at least one locator fixed to said at least one lifting rail, said locator adapted to register with a locator receptor on the underbody component so that, as said lifting rail moves from said lower position to said upper position, said lifting rail elevates the underbody component from the conveyor to a predetermined position, and
a lifter at said assembly station for selectively moving said lifting rail between said upper and said lower position.

2. The invention as defined in claim 1 and comprising two lifting rails vertically slidably mounted to each frame, one of said lifting rails being mounted to one side of said frame and the other lifting rail being mounted to the other side of said frame.

3. The invention as defined in claim 1 wherein each locator comprises a pin and wherein each locator receptor comprises an opening in the underbody component.

4. The invention as defined in claim 1 and comprising at least three frames.

5. The invention as defined in claim 1 and comprising means at said assembly station for fixedly securing said body components together.

6. The invention as defined in claim 5 wherein said fixed securing means comprises a welder.

7. The invention as defined in claim 5 wherein said fixed securing means comprises a clinching system.
